(19) United States
(12) Patent Application Publication
(10) Pub. No.: US 2005/0278723 A1
(43) Pub. Date: Dec. 15, 2005

(54) System and method for remote administration from a windows client of computer systems running the Linux operating system

(76) Inventors: David A. Feinleib, Kirkland, WA (US); Brian K. Moran, Preston, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/866,937

(22) Filed: Jun. 14, 2004

(51) Int. Cl. G06F 9/46

(52) U.S. Cl. 719/310; 709/223

(57) ABSTRACT

A system and method for remote administration and management of computers running a version of the Linux or UNIX operating system from a management interface running on a client running a version of the Microsoft Windows operating system. More specifically, the invention relates to a number of software modules, communications protocols, and processes for this remote administration. The software modules include a remote management snap-in running on a Windows client, and a remote management daemon and configuration module running on a remotely managed Linux or UNIX system. In response to user inputs, commands are generated by the snap-in and sent to the daemon. The daemon interacts with the configuration module to retrieve current configuration information or effect a change to the configuration. The daemon then generates a response that includes information concerning the current configuration, which is then displayed in the snap-in. In one embodiment, the snap-in runs in the Microsoft Management Console, enabling users to manage remote non-Windows systems using familiar interface.

### FIELD OF THE INVENTION

The field of invention relates generally to a system and method for remote administration and management of computers running the Linux operating system from a management interface running on a computer running the Windows operating system. More specifically, the invention relates to software processes and methods that are used in the management client software, the management server software, and the communications protocols required for the client and one or more servers to interact.

### BACKGROUND INFORMATION

It can be appreciated that for many years, computers have been used to store data. Similarly, computer printers have been attached to such computers to allow such data to be printed to paper. To make it possible to share data, printers, and other resources, computer networks evolved. A common design of networks is a server computer that is accessed by one or more client computers. In this way, the server computer is a shared resource, providing access to data stored on it, as well as to other resources such as printers that are attached to it either directly, by a network, or other means. It will be recognized that the network referred to could be a wire-based network such as an Ethernet network, a wireless network, or some other kind of network. Another aspect of such networks is that the server computers authenticate access to themselves and the resources they provide. Much as a person must display his or her credentials when passing through a security checkpoint to, for example, enter a building, a user on a computer network requiring authentication must provide security credentials to gain access to a specified resource. One example of the aforementioned authentication scheme is the Domain Controller system implemented by the Microsoft Windows family of operating systems, in which a particular server runs as a Domain Controller, authenticating users to access particular network resources.

To store data and provide access to resources, the server computers described typically run an operating system, which is a piece of software that controls the basic functions of the server. The operating system, by itself, or in conjunction with additional modules installed on top of it, provides functions such as file and print sharing, as well as the authentication services described above. One such operating system is the Microsoft Windows operating family of operating systems, including products such as Microsoft Windows NT, Microsoft Windows Server 2000, and others. Another such operating system is the Linux operating system, distributed by companies such as Red Hat, Novell, and others. A third such operating system is the FreeBSD operating system. There also exist implementations in which the entire system, including functions typically provided by the operating system, is implemented in hardware, for example in a single chip, such as the BCM47MMC80 chip from Broadcom.

Similarly, client machines run an operating system and other modules or programs to gain access to data and resources stored on the server. One example of a client operating system is the Microsoft family of operating systems, including Windows 95, Windows 98, Windows 2000, Windows XP, and others. For the clients and servers to communicate with each other, they must transfer data over a common protocol, similar to the way that two people must speak the same language to communicate with each other. One common protocol is the Server Message Block protocol, or SMB. SMB is a protocol used for sharing files, printers, serial ports, and other types of communications resources. One skilled in the art will recognize that SMB can operate on top of multiple underlying network protocols, such as the TCP/IP protocol. One implementation of SMB is the Common Internet File System (CIFS).

Authentication also requires a common protocol between client and server. One such protocol is called NTLM (NT LanMan (LAN Manager)). NTLM is implemented by a number of operating systems, such as the Microsoft Windows family of operating systems. NTLM is also implemented by the Samba program, a program that runs on the Linux operating system, among others, and provides the SMB/CIFS and NTLM protocols to servers running Linux, allowing these servers to provide access to their resources to clients running the same protocol, such as clients running a member of the Microsoft Windows family of operating systems.

In addition to file, print and authentication services, servers provide other services such as networking services like the Domain Name Service (DNS), a name lookup service, the Dynamic Host Configuration Protocol (DHCP), which allows an Internet Protocol (IP) address to be assigned to a client computer dynamically, and others. Additional services may include the ability to back up data, scan for viruses, and other functions.

As such, a server is a complex device to operate. A system administrator, the person responsible for setting up a server and for its on-going operation, must configure all the services properly, ensure that hardware is correctly installed, configure the file shares to be made accessible to clients, configure permissions that determine who will be authenticated for what resources, and so on. This is a very complex, time-consuming, and error-prone process. System Administrators often require years of training before they become experts. For a given server operating system, the interface and services, while providing similar capabilities to clients (because they support the same protocol), are often configured through very different user interfaces. This means that an administrator skilled in the operation of a Windows Server might find it difficult or impossible to configure a server running the Linux operating system without significant training.

Windows administrators, for example, are typically familiar with the widely used Microsoft Management Console (MMC), a program used to manage Windows Servers. The Microsoft Management Console is a management framework program, meaning that it supports a number of snap-ins, e.g. additional modules, developed by Microsoft or by third parties. Such snap-ins present their user interface within the MMC, and are built and developed as libraries that are loaded by the MMC.

A Linux administrator, however, is more likely to use the command line and to edit configuration files by hand. Thus, administrators who would like to run the Linux operating system on their server but who are only familiar with administering a server running the Windows operating system find it difficult or impossible to deploy a server running the Linux operating system because they cannot configure and operate it using a familiar interface.

It will be recognized that server computers may be administered using a keyboard, mouse, and monitor directly attached to the server. But more often than not, such administration is done remotely, e.g. over a network connection. While the protocols for sharing resources and authenticating users are well-documented, those for remotely administering a particular server operating system are not.

Traditionally, administrators had little desire to run mixed environments, in which a server would run the Linux operating system while a client would run a Windows operating system. More recently, however, administrators have, for a variety of reasons, desired to run the Linux operating system to serve clients running the Windows operating system. As described above, however, such administrators face the difficult problem of having to learn a different user interface to configure and operate the server. The present invention addresses this problem by making it possible for these administrators to administer one or more Linux servers from a Windows client, and more specifically, in other words, through an interface with which they are familiar and comfortable, reducing to almost zero their learning curve, and increasing their ability to deploy their operating system of choice on the server, without having to worry about what interface they will use to administer it.

### SUMMARY OF THE INVENTION

In accordance with aspects of the present invention, embodiments of systems and methods for remote administration and management of computers running the Linux operating system from a management interface running on a computer running the Windows operating system are disclosed. More specifically, the embodiments relate to a number of software modules, communications protocols, and processes for this remote administration. By enabling system administrators, e.g. those who manage computer systems, to manage one or more servers running the Linux operating system from a system running Windows, the invention provides a unique and novel way for administrators to manage these servers.

In one aspect, a remote management snap-in (a programmatic library) is installed on a machine running a member of the Windows family of operating systems and operates in the Microsoft Management Console (MMC), a general framework program used for managing computer systems. The snap-in provides an administrator with a user interface to view information about and to configure a remote server. The snap-in communicates with a daemon (a software program) running on the server, to send commands to and receive commands from the server. Settings viewable and configurable by the user via the snap-in include file shares available, users that can access them, printer resources, network settings and services, hardware configuration information, and other configuration settings. One skilled in the art will recognize that the settings described here are not exhaustive and may include but are not limited to the ability to start and stop services, to view and edit a print queue, to configure authentication and directory services, and the like. One skilled in the art will also recognize that the snap-in may be running on a Windows computer connected by a network link to the server, or it may be running on the server itself, either inside a virtual machine running the Windows operating system, or on top of a compatibility library that allows Windows programs to run on a machine running the Linux operating system.

In another aspect of the present invention, a communication protocol is used to allow the client and server to communicate, such that the client can send commands to the server, and the server can send information to the client, to alert the client to changes to the system, and so on.

In another aspect of the present invention, the commands sent and received are described using the Extensible Markup Language (XML), a language used to describe information. XML is a simple, flexible text format originally designed to meet the challenges of large-scale electronic publishing, but adapted, for the present invention, to describe commands and results for server management. It will be recognized that other description languages could be used, such as raw text or programmatic structures. The XML can be sent as text or compiled into binary form to take up the least space possible during transmission. The XML commands are described by a schema that indicates the types of data and commands that the snap-in and remote management daemon/configuration module can process.

In another aspect of the present invention, the commands are sent over a secure link. In the particular implementation, the link is a secure shell (SSH) link, but it will be recognized that any of a number of secure link mechanisms can be used, including Secure Sockets Layer (SSL), among others. Commands and data can be sent over an unencrypted, non-secure link. However, it is important that servers be managed in a secure fashion so that people without rights to access the server or malicious programs such as computer viruses do not gain access to the server and alter its operation.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of a system architecture support remote management of computers running Windows operating system with a client running a Linux or UNIX operating system, according to one embodiment of the invention;

FIG. 2 is a schematic diagram illustrating sending and receiving commands and data under the remote management architecture of FIG. 1;

FIG. 3 shows a screenshot of a snap-in component running within a management console that is used under the remote management architecture;

FIG. 4 shows an exemplary XML message format used to send a command to a server being managed;

FIG. 5 shows a listing of an exemplary XML message remote management daemon sends to the client snap-in in response to one particular command;

FIG. 6 is a flowchart illustrating operating and logic implemented during execution of one embodiment of the remote management process of the present invention;

FIG. 7 is a flowchart illustrating operation and logic performed during configuration changes under the remote manager, according to one embodiment of the invention; and

FIG. 8 is a schematic diagram illustrating the programmatic architecture of the remote management snap-in shown in FIG. 3.

FIG. 9 is a schematic diagram of an exemplary computer system for practicing embodiments of the invention.

### DETAILED DESCRIPTION

Embodiments of method and apparatus for remote management of a server running a version of the Linux or UNIX operating system from a client computer running a version of the Windows operating system are described herein. In the following description, numerous specific details are set forth (such as the C and C++ programming languages indicated as the language in which the software described is implemented) to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

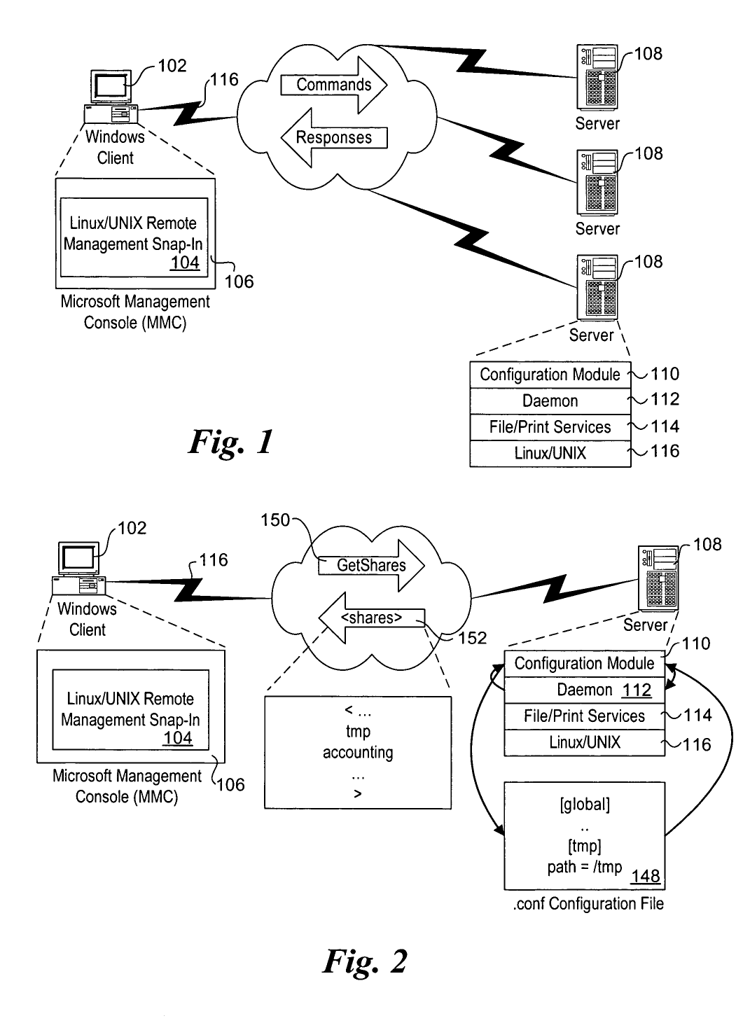

FIG. 1 shows a remote management architecture 100 under which a user operating a Windows client 102 is enabled to remotely manage one or more remote servers 108. Each of remote servers 108 runs a variant of one of a Linux or UNIX operating system, and is thus referred to as a “Linux system” or a “UNIX system,” accordingly. In one embodiment, remote management operations are facilitated by a Linux or UNIX remote management snap-in software component (remote management snap-in) 104 running on Windows client 102. The remote management snap-in displays information to a user, sends commands to a remote management daemon 112 running on a server 108 over a communications link 16, and receives information from remote management daemon 112. The Windows client is depicted as a computer, such as but not limited to a personal computer, laptop computer, workstation, or server, running a member of the Microsoft Windows family of operating systems, such as Windows 98, Windows 2000 Professional, Windows XP, and the like. In one embodiment, the remote management snap-in 104 is installed and operates in the Microsoft Management Console 106, a general-purpose management program that is included with many versions of Windows. Several components are shown running on server 108, including a configuration module 110, remote management daemon 112, file/print service 114, and Linux or UNIX operating system (OS) 116.

During a typical remote management operation, remote management snap-in 104 sends commands over communication link 116 to remote management daemon 112. In another embodiment, a computer emulation environment, such as “Microsoft Virtual PC” or “VMWare Workstation” runs on computer 102. A version of the Linux operating system is installed inside the emulation environment, and server 108 resides as a virtual machine inside the emulation environment. In this embodiment, commands are routed to the computer emulation environment running on computer 102.

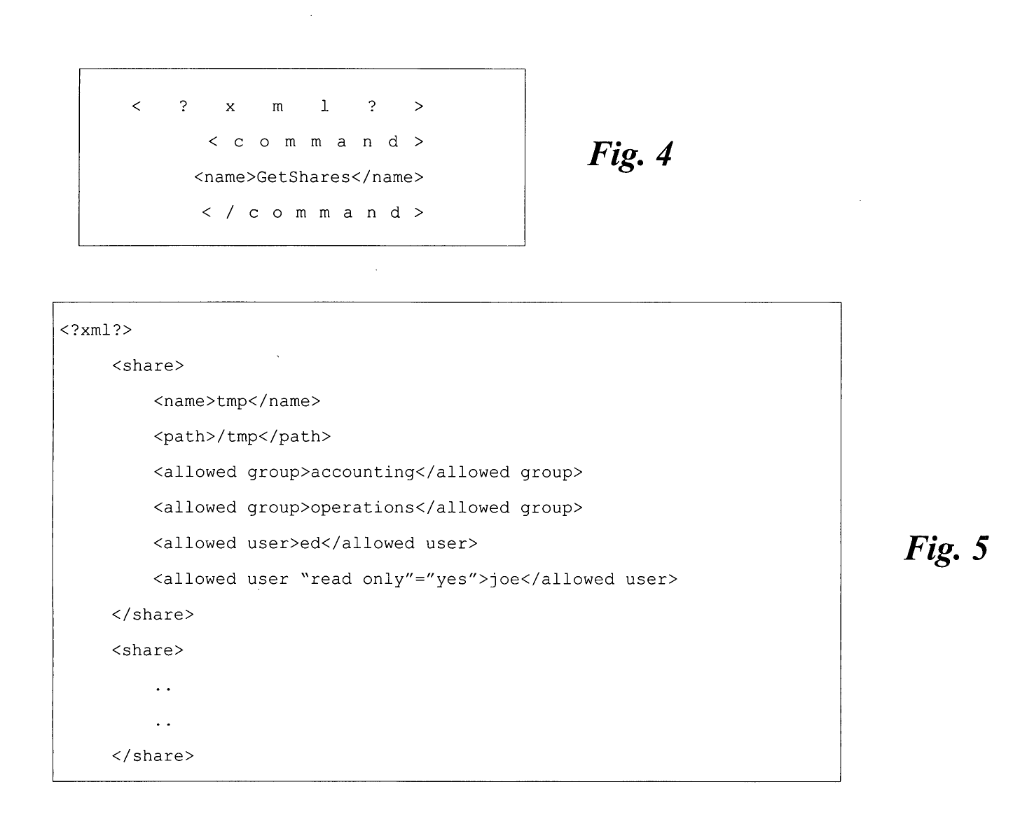

In one embodiment, commands are written in the Extensible Markup Language (XML); an exemplary XML command format is shown in FIG. 4. In another implementation, the commands are written in a raw text format. In yet another implementation the commands are sent as programmatic structures. In another implementation, the commands are sent as a combination of one or more of the above.

FIG. 2 illustrates a round-trip loop of a command sent from remote management snap-in 104 to remote management daemon 112 and a returned response. When the user launches the snap-in, the snap-in contacts server 108 and establishes communication with the remote management daemon 112 over communication link 116. In the illustrated embodiment, a GetShares command 150 is sent having the XML format shown in FIG. 4 to remote management daemon 112. The GetShares command 150 indicates to remote management daemon 112 that client 102 wants to receive a list of shares that are available on server 108. When remote management daemon 112 receives the GetShares command 150, it processes the command and determines that the client wants to receive a list of shares. It forwards this command to Configuration Module 110, which, in this example, opens a smb.conf configuration file 148 for reading. It processes the file, determining what shares are available to the client. Configuration module 110 then generates an XML response message 152 to describe the share information found and passes the information to remote management daemon 112. The remote management daemon sends the XML-formatted response message back to client 102 over communications link 116. The snap-in then parses the XML describing the available shares. It then displays these shares in its user interface, which is displayed inside the MMC framework application 106.

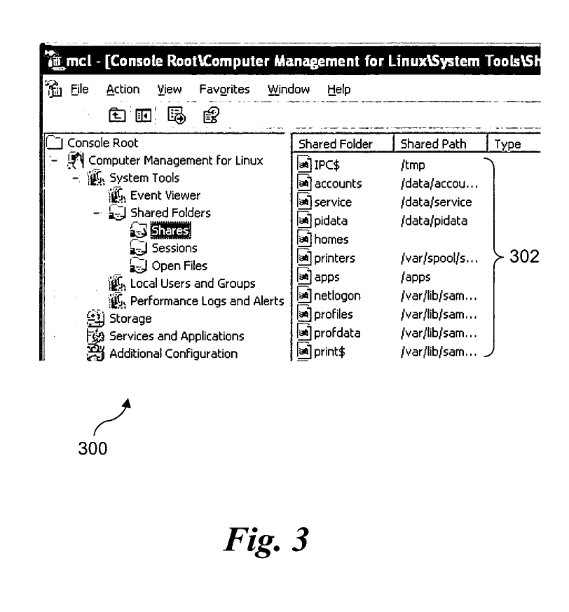

FIG. 3 shows an exemplary screenshot 300 of a snap-in management console screen facilitated by remote management snap-in 104. The snap-in management console screen is visible inside the MMC 106. In this exemplary screenshot, the snap-in user interface shows a list of shares 302 on a remotely-managed Linux or UNIX system. In one embodiment, the snap-in is written in a combination of the C and C++ programming languages. It will be recognized that a number of programming languages could be used, including Visual Basic, C#, and others. The remote management snap-in displays a variety of information to the user, including, but not limited to, what shares are available on the server machine, information about users and groups, network settings, system status such as what shares are connected to and by whom, and other relevant information. The user interacts with the user interface to create new shares, delete existing shares, add and remove printers, and to get information about and configure other aspects of the managed server.

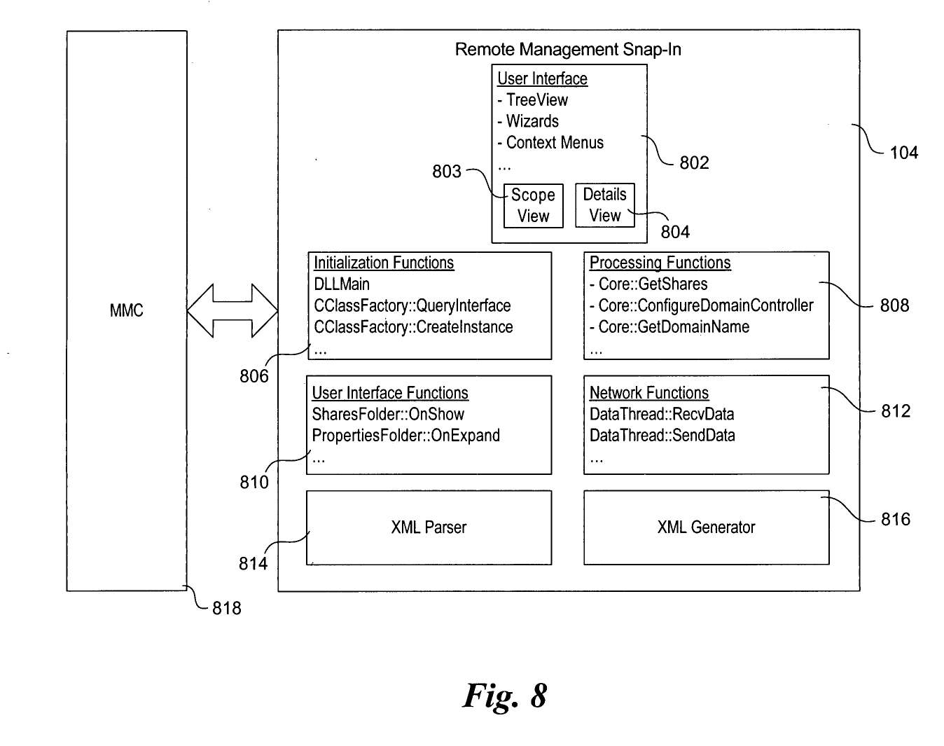

FIG. 8 shows details of a software architecture corresponding to one embodiment of remote management snap-in 104. The software architecture comprises a number of components, including a User Interface 802, which displays information to the user and receives input from the user. The User Interface provides various windowing controls, such as one or more treeview controls, wizards, and context menus. In one embodiment, User Interface 802 comprises two primary display panes, including a scope view 803 and a details view 804.

Remote management snap-in 104 is implemented with a number of programmatic functions. In particular, initialization functions 806 are called by MMC 818 to load the snap-in. In one embodiment, a DLLMain function loads remote management snap-in 104, while a QueryInterface function call returns the interfaces, e.g. other functions, supported by snap-in 104, and a CreateInstance function call creates instances of the classes supported by the snap-in.

Remote management snap-in 104 includes various user interface functions 810 that display information to the user and receive input from the user. In one embodiment, a function OnShow in class SharesFolder creates columns in the user interface and adds the names and descriptions of shared folders to the user interface. Function OnExpand of class PropertiesFolder expands the contents of the treeview containing properties of a computer that the remote management snap-in is managing. In addition to the aspects of remote management snap-in illustrated in FIG. 3, the user interacts with the snap-in through other user interface elements that the snap-in displays. These include, but are not limited to: popup menus and configuration wizards.

Remote management snap-in 104 further includes an XML Parser 814, which parses XML data returned from remote management daemon 112, such as the exemplary fragment shown in FIG. 5, which is described in more detail below. An XML Generator 816 creates commands to be sent to remote management daemon 112, such as the exemplary fragment shown in FIG. 4, which is also described in more detail below.

Remote management snap-in also includes various network functions 812, which are responsible for sending data to and receiving data from the remote management daemon. For example, function RecvData of class DataThread receives data using TCP/IP socket functions, while function SendData of class DataThread sends data, such as the XML fragment shown in FIG. 4, to remote management daemon 112.

Processing functions 808 interact with the functions and mechanisms described above to perform the processing work of remote management snap-in 104. Function GetShares of class Core interacts with network functions 812 and XML Generator 816 to get the names and descriptions of shares from remote management daemon 112. Function ConfigureDomainController of class Core interacts with the aforementioned functions to configure a target server as a domain controller. Function CreateFileServer of class Core interacts with the aforementioned functions to create and configure a file server, that is, to send the appropriate commands to remote management daemon 112 so that server 108 is configured as a file server.

In an innovative technique, the present invention displays a series of screens making up a wizard to the user through the interface running on Windows client 102, but the result of these wizards, such as modifications to server configuration, occur on the remote server (e.g., server 108) running the Linux operating system or a UNIX-based OS.

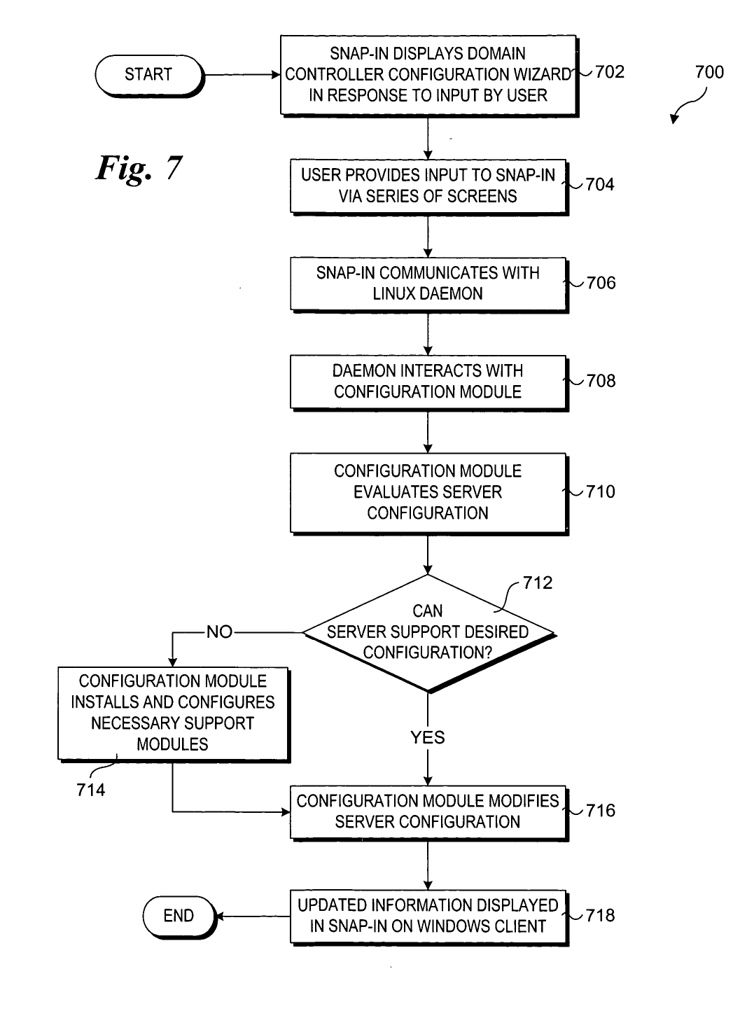

For example, operations and logic performed during a domain controller configuration process are shown in FIG. 7. The process begins in a block 702, wherein remote management snap-in 104 displays a domain controller configuration wizard in response to input by the user. Remote management snap-in 104 displays a series of screens to the user, allowing the user to provide configuration information and choose configuration options, as depicted in a block 704. For instance, this information includes, but is not limited to, the name and type of the domain controller. Throughout the process, remote management snap-in 104 communicates with remote management daemon 112 to obtain and set configuration information, as depicted by a block 706. Remote management daemon 112 interacts with configuration module 110 in a block 708 to alter the server configuration. Before altering the server configuration, configuration module 110 evaluates the server configuration to determine if the software installed on the server will support the desired configuration. If configuration module 110 determines at decision point 712 that the server cannot support the desired configuration, then configuration module 110 attempts to install and configure the necessary software modules in accordance with block 714. In one embodiment, such modules are downloaded from an Internet server (not shown). It will be recognized that such modules may reside on removable media such as a recordable compact disc, on a hard drive, or on another server.

If the necessary software modules are already installed, or once they are installed in block 714, configuration module 110 modifies the server configuration in a block 716. Remote management daemon 112 then returns updated status information to remote management snap-in 104 in a block 718, with the status information being displayed in MMC 106 running on windows client 02. It will be recognized that the updated information may or may not be displayed immediately; rather it might be available to the user through other user interface options, through voice commands, or other means.

FIG. 4 shows an XML format used in one particular command, the GetShares command, which the snap-in uses to request information about the available shares from server 108. One skilled in the art will recognize that the XML fragment shown in FIG. 4 may vary depending on a particular implementation. The command is specified by the <name> tag, which encloses the command name, GetShares. In this case, GetShares is a simple command; however, for more complex commands, parameters would be specified for the command.

FIG. 5 shows an exemplary XML fragment returned in response to the GetShares command; the specified XML describes the shares available on server 08. The server sends this XML to the snap-in on the client to indicate what shares are available in response to the GetShares command requesting this information. One skilled in the art will recognize that the XML fragment shown in FIG. 5 may vary depending on a particular implementation. In the fragment shown, the <share> tag indicates that the elements that follow describe a share available on the server. If the server has no shares, then no shares are described; otherwise one or more shares are indicated. The <name> tag indicates the name of the share. The <path> tag indicates the path of the share, e.g. the actual share location on disk. The <allowed user> tag indicates a user that is allowed to access the share; the <allowed group> tag indicates a group that is allowed to access the share. Zero or more <allowed user> and <allowed group> tags are possible. In the <allowed user> tag, “read only” is specified to indicate that an exemplary user “Joe” has only read-only access to the specified share, e.g. Joe can view files that are on the share but cannot write to the share. Other properties are possible for each user and group, but are not specified here to avoid confusion.

The GetShares command shown in FIG. 4 and the response shown in FIG. 5 illustrate one of many commands that may be facilitated by remote management architecture 100. It will be recognized that the command name GetShares is representative of a number of command names that could be used. Other commands supported by the present invention include, but are not limited to the GetUsers command, which returns the names of users available in the system; the GetShareUsers command, which returns the users that can access a specified share and the permissions associated with that access; the SetShare command, which modifies an existing share or creates a new one; the AddUser command which adds a user to the system; the DeleteUser command, which deletes a user from the system; and the AddShareUser command, which gives a specified user access to a share with the specified permissions.

Furthermore, data may be sent from remote management daemon 112 to Windows client 102 even without the client requesting information from the server; for example, when a user connects to a share on the server and the user connection count increases for the specified share, the server sends a notification message to the client, indicating the increased connection count for the specified share. Other notification messages are possible.

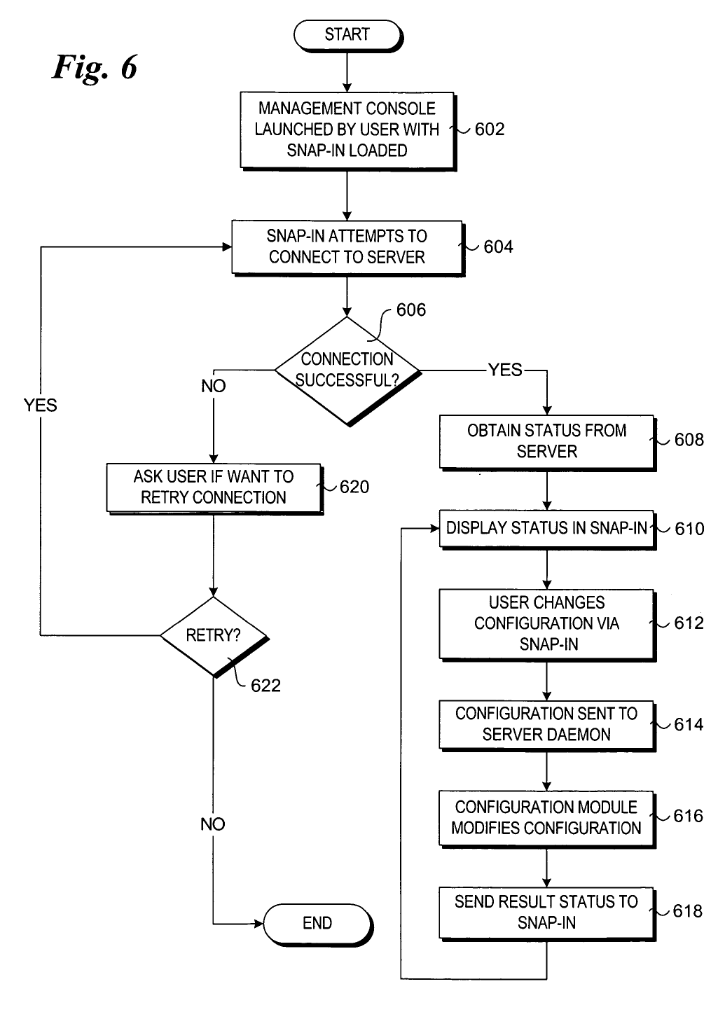

FIG. 6 is a flowchart showing the process flow for configuring remote management snap-in 104 and remote management daemon 112. First, in a block 602 management console 106 is launched by the user with the snap-in loaded. The management console runs on Windows client 102, with remote management snap-in 104 running in the process space of management console 106. After initialization, remote management snap-in 104 attempts to connect to remote management daemon 112 in a block 604. In one embodiment, remote management snap-in 104 connects to remote management daemon 112 over a wireless network running the TCP/IP protocol. In one embodiment, if remote management snap-in 104 fails to connect to remote management daemon 112, at decision point 606, snap-in 104 queries the user to determine if the user wants to retry a connection, as depicted in a block 620. It will be recognized that such a query could be presented in the form of an on-screen window, a voice prompt, or other means. If the user chooses to retry the connection, the settings used to connect to the server may be modified via the user interface of remote management snap-in 104, or the connection is retried with the same settings in block 604. It the user chooses not to retry the connection at decision point 622, the process ends.

If remote management snap-in 104 successfully connects to remote management daemon 112, the process proceeds to a block 608, wherein the snap-in queries remote management daemon 112 for status information, including, but not limited to, directories that are shared on the server. Remote management daemon 112 sends the status information back to Windows client 102, and remote management snap-in 104 displays the status information in a block 610. While remote management snap-in 104 is running, the user interacts with the snap-in to change configuration settings in a block 612. In one embodiment, the user creates a new file share via remote management snap-in 104. In a block 614, the configuration changes are sent over the network to remote management daemon 112. In response, remote management daemon 112 interacts with configuration module 110 SO that the server configuration is modified, as depicted in a block 616. After the configuration modification completes, status is returned to snap-in 104 in a block 618 to complete the process.

It will be recognized that communication that occurs between remote management snap-in 104 and remote management daemon 112 can occur in a variety of ways. In one embodiment, the connection is established and maintained between remote management snap-in 104 and daemon server 112. In another embodiment, the connection is created and terminated for each communication between remote management snap-in 104 and remote management daemon 112. In yet another embodiment, no connection is established; messages are sent via the connectionless User Datagram Protocol (UDP).

As discussed above, the remote management functions are implemented via execution of software components on a Windows client and the remote server(s) being managed. Thus, embodiments of this invention may be used as or to support a software program executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

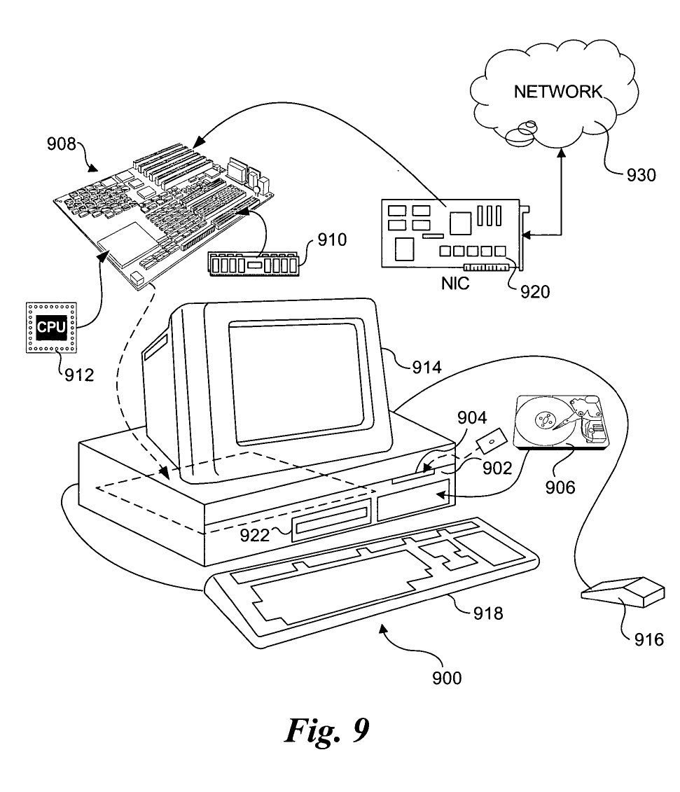

FIG. 9 illustrates an embodiment of an exemplary computer system 900 to practice embodiments of the invention described above. Computer system 900 is generally illustrative of various types of computer devices, including personal computers, laptop computers, workstations, servers, etc. For simplicity, only the basic components of the computer system are discussed herein. Computer system 900 includes a chassis 902 in which various components are housed, including a floppy disk drive 904, a hard disk 906, a power supply (not shown), and a motherboard 908. Hard disk 906 may comprise a single unit, or multiple units, and may optionally reside outside of computer system 900. The motherboard 908 includes a memory 910 coupled to one or more processors 912. Memory 910 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Processor 912 may be a conventional microprocessor including, but not limited to, a CISC (complex instruction set computer) processor, such as an Intel Corporation x86, Pentium, or Itanium family microprocessor, a Motorola family microprocessor, or a RISC (reduced instruction set computer) processor, such as a SUN SPARC processor or the like.

A monitor 914 is included for displaying graphics and text generated by firmware, software programs and program modules that are run by computer system 900, such as system information presented during system boot. A mouse 916 (or other pointing device) may be connected to a serial port, USB (Universal Serial Bus) port, or other like bus port communicatively coupled to processor 912. A keyboard 918 is communicatively coupled to motherboard 908 in a similar manner as mouse 916 for user entry of text and commands. In one embodiment, computer system 900 also includes a network interface card (NIC) or built-in NIC interface (not shown) for connecting computer system 900 to a computer network 930, such as a local area network (LAN), wide area network (WAN), or the Internet.

Computer system 900 may also optionally include a compact disk-read only memory (“CD-ROM”) drive 922 into which a CD-ROM disk may be inserted so that executable files, such as an operating system, remote management snap-in, remote management daemon, and data on the disk can be read or transferred into memory 910 and/or hard disk 906. Other mass memory storage devices may be included in computer system 900.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method for remotely managing a Linux system with a Windows client, comprising:
installing a remote management snap-in software component on the Windows client, the remote management snap-in providing a user interface via which management data are presented to a user;
installing a remote management daemon on the Linux system;
sending a command generated by the remote management snap-in to the remote management daemon to retrieve management information from the Linux system;
retrieving management information requested in the command from the Linux system;
sending the management information that is retrieved from the remote management daemon as a response to the remote management snap-in; and
displaying the management information in the remote management snap-in user interface.

2. The method of claim 1, further comprising:
loading a configuration module on the Linux system; and
employing the configuration module to retrieve the management information from the Linux system.

3. The method of claim 1, wherein the configuration information comprises file share information, and file share data for the Linux system are displayed in the remote management snap-in user interface.

4. The method of claim 1, wherein the remote management snap-in is installed in a Microsoft Management Console (MMC) component of a Windows operating system.

5. The method of claim 1, wherein the command and the response are sent as extended markup language (XML)-formatted text.

6. The method of claim 1, further comprising:
enabling, via a user input, a user to modify a configuration of the Linux system via the remote management snap-in user interface;
generating a command to modify the configuration of the Linux system in response to the user input;
sending the command to the remote management daemon;
modifying the configuration of the Linux system in response to the command;
sending a response back to the remote management snap-in including information pertaining to the modified configuration of Linux system; and
displaying the information pertaining to the modified configuration in the remote management snap-in user interface.

7. The method of claim 6, wherein the configuration modification pertains to a modification of at least one of file and print shares hosted by the Linux system.

8. A method for remotely managing a UNIX system with a Windows client, comprising:
installing a remote management snap-in software component on the Windows client, the remote management snap-in providing a user interface via which management data are presented to a user;
installing a remote management daemon on the UNIX system;
sending a command generated by the remote management snap-in to the remote management daemon to retrieve management information from the UNIX system;
retrieving management information requested in the command from the UNIX system;
sending the management information that is retrieved from the remote management daemon as a response to the remote management snap-in; and
displaying the management information in the remote management snap-in user interface.

9. The method of claim 8, further comprising:
loading a configuration module on the UNIX system; and
employing the configuration module to retrieve the management information from the UNIX system.

10. The method of claim 8, wherein the configuration information comprises file share information, and file share data for the UNIX system are displayed in the remote management snap-in user interface.

11. The method of claim 8, wherein the remote management snap-in is installed in a Microsoft Management Console (MMC) component of a Windows operating system.

12. The method of claim 8, wherein the command and the response are sent as extended markup language (XML)-formatted text.

13. The method of claim 8, further comprising:
enabling, via a user input, a user to modify a configuration of the UNIX system via the remote management snap-in user interface;
generating a command to modify the configuration of the UNIX system in response to the user input;
sending the command to the remote management daemon;
modifying the configuration of the UNIX system in response to the command;
sending a response back to the remote management snap-in including information pertaining to the modified configuration of UNIX system; and
displaying the information pertaining to the modified configuration in the remote management snap-in user interface.

14. The method of claim 13, wherein the configuration modification pertains to a modification of at least one of file and print shares hosted by the UNIX system.

15. A machine-readable medium, to provide software modules including:
a remote management snap-in, configured to be executed in a Microsoft Management Console running on a Windows client,
a remote management daemon, configured to be installed and executed on one of a Linux or UNIX system; and
a configuration module, configured to be installed and executed on said one of the Linux or UNIX system,
wherein, upon execution, the remote management snap-in, remote management daemon, and configuration module interact with one another to enable a user of the Windows client to remotely manage configuration of said one of the Linux or UNIX system.

16. The machine readable medium of claim 15, wherein the remote management snap-in comprises:
a user interface module to provide a user interface that enables a user to view and modify configuration settings for said one of the Linux or UNIX system;
an XML generator, to generate XML-formatted commands that are sent from the remote-management snap-in to the remote management daemon; and
an XML parser, to parse XML-formatted responses sent from the remote-management daemon.

17. The machine-readable medium of claim 15, wherein execution of the remote management snap-in, remote management daemon, and configuration module enable performance of operations including:
enabling, via a user input entered via the remote management snap-in, a user to modify a configuration of said one of a Linux or UNIX system;
generating a command to modify the configuration of said one of a Linux or UNIX system in response to the user input;
sending the command to the remote management daemon executing on said one of a Linux or UNIX system;
modifying the configuration of said one of a Linux or UNIX system in response to the command;
sending a response back to the remote management snap-in including information pertaining to the modified configuration of said one of a Linux or UNIX system; and
displaying the information pertaining to the modified configuration in the remote management snap-in user interface.

18. The machine-readable medium of claim 17, wherein the configuration modification pertains to a modification of at least one of file and print shares hosted by said one of a Linux and UNIX system.
